(19) United States
(12) Patent Application Publication
(10) Pub. No.: US 2014/0000037 A1
(43) Pub. Date: Jan. 2, 2014

(54) CLAMPING SYSTEM FOR CUSHIONING ELEMENTS

(71) Applicant: Bryan B. Donohue, Rochester, MN (US)

(72) Inventor: Bryan B. Donohue, Rochester, MN (US)

(21) Appl. No.: 13/538,256

(22) Filed: Jun. 29, 2012

(51) Int. Cl. A47G 9/10; H01F 7/02; F16B 2/06

(52) U.S. Cl. 5/639; 5/490; 24/303

(57) ABSTRACT

A clamping system for releasably affixing a replaceable sheet to the exterior of a pillow case to provide a replaceable sleeping or resting surface. Two opposing frame members that can be magnetically engaged together are positioned on opposite sides of the pillow case. A replaceable sheet can be positioned between the exterior frame member and the pillow to engage the replaceable sheet to the exterior of the pillow case. The frames can be pulled apart to release and replace the replaceable sheet. A stack of replaceable sheets can be clipped with the frames such that a fresh sleeping surface can be provided simply by removing the top most sheet.

### FIELD OF THE INVENTION

The present invention is generally directed to a clamping system for affixing a cover or other object to a pillow with a pillow case that is fitted over a pillow case. More specifically, the present invention is directed to a clamping system for affixing a replaceable sheet or other generally planar item to a pillow case of a pillow.

### BACKGROUND OF THE INVENTION

Pillows are commonly fitted with a removable pillow case that can be easily separated from the pillow cushion and laundered to provide a clean sleeping or resting surface while prolonging the life of the cushion. A pillow case typically comprises a fabric pocket into which the cushion is inserted. The pocket often comprises an opening through which the cushion can be inserted or removed. Although a pillow case can be easily separated from the cushion, certain applications for pillow cushions require a more efficient and/or cost effective means of presenting a clean sleeping surface.

One application is a hospital or other patient setting where a sterile sleeping surface is necessary to reduce the likelihood of secondary infections or ailment. Although the pillow case can be removed and laundered after each use, the laundering may not sufficiently sterilize the pillow case. In addition, laundering the pillow case with other contaminated pillow cases may cross-contaminate the pillow cases compounding the problem. A similar problem is that the pillow cases may have to be replaced on a daily or even more frequent basis requiring multiple spare pillow cases for each pillow while soiled pillows are being laundered. Depending on the frequency with which the pillow cases are being replaced, the supply of sterile pillow cases may be quickly exhausted.

Another application where a conventional pillow case arrangement may be insufficient is in hospitality or other large scale housing settings where a relatively large number of pillow cases may have to be continuously replaced and laundered. In addition to potentially exhausting the supply of clean pillow cases, the overall time required to collect soiled pillow cases and put on the replacement pillow case can be significant with a large number of pillows. The volume of pillow cases can also require a significant amount of energy to launder. As energy efficiency is an increasing concern, continuous laundering of large amounts of pillow cases may be ineffective use of energy. Moreover, the use and cost of bleach, dyes, detergents and other cleaning chemicals as well as other consumables such as dryer sheets cab present both ecological and economical concerns.

Finally, individual consumers may wish to have a clean sleeping or resting surface each day. Unlike patient care or large scale housing, the individual consumer may not have the resources or the time to launder even a relatively limited number of pillow cases each day or several times a week. Moreover, as many medical treatments for many common ailments often involve bed rest at home, individual consumers often have the same need of frequently providing a clean sleeping or resting surface. Similarly, individual consumers often desire to provide a clean sleeping surface for house guests, but do not have the time or resources to launder pillow case for each house guest. In addition, even if an individual regularly launders the pillow case, the cleanliness of the pillow case may still be compromised. The laundering process may not remove all the contaminants from the pillow case and may cross-contaminate the pillow case from other items being laundered.

As such, there is a need for efficiently providing a clean or even sterile sleeping or resting surface. In addition to minimizing the time required to provide a new sleeping surface, there is a need for providing an energy efficient means of sterilizing and replacing the sleeping surface.

### SUMMARY OF THE INVENTION

The present invention is directed to a clamping system that can be used to releasably affix a replaceable sheet to the exterior of a pillow case. The clamping system can also be used to releasably affix generally planar objects including, but not limited to dry-erase boards, clipboards, mirrors, tablet computers. According to an embodiment of the present invention, the clamping system comprises two opposing frame members positioned on the interior and exterior side of the pillow case. Each frame member comprises a plurality of magnets corresponding to magnets on the opposing frame member such that the frame members can be magnetically engaged to pinch the pillow case between the frame members. A replaceable sheet can be positioned between the exterior frame member and the pillow case such that magnetically engaging the frame members releasably engages the replaceable sheet to the exterior of the pillow case. In another aspect, the replaceable sheet can be engaged against the interior face of the pillow case such that the replaceable sheet is positioned within the pillow case. After use, the frames can be pulled apart to release the used replaceable sheet such that a fresh replaceable sheet can be substituted for the used sheet. In one aspect, a stack of replaceable sheets can be placed between the frames such that a fresh sleeping surface can be provided simply by removing the top most sheet.

A clamping system, according to an embodiment of the present invention, comprises an interior frame member having a first plurality of magnets and an exterior frame member having a second plurality of magnets corresponding to the first plurality of magnets. The interior frame member is positionable on the interior side of a pillow case fitted over a pillow. Correspondingly, the exterior frame member is positionable on the exterior side of the pillow case such that the first and second pluralities of magnets are aligned to engage the first and second frame members together. A replaceable sheet can be positioned between the exterior frame member and the pillow case to clamp a replaceable sheet to the pillow case. The interior and exterior frame members each define an opening sized to allow a user to rest their head or other body part against the pillow without contacting either frame members. The replaceable sheet can be sized to cover the entire opening.

In one aspect, the clamping system can be used to engage a planar object to the pillow case of a pillow, such as a tablet computer or a white board, to a pillow. In one aspect, the clamping system can further comprise a planar support surface having a third plurality of magnets corresponding to the first plurality of magnets and a fourth plurality of magnets corresponding to the second pluralities of magnets. The planar support surface can be integrated into either the interior or exterior frame member to provide a surface for receiving the planar object or provided separately and engaged to either frame member. As with the replaceable sheet, the planar surface can be positioned against the exterior face of the pillow case or within the pillow case. The third and fourth pluralities of magnets can be adapted to engage a metal portion of the planar object or corresponding magnets affixed to the planar object such that the planar object is affixed to the support surface. Alternatively, the entire planar support surface can be magnetic to engage the corresponding magnets or metal surfaces of the planar object. In either configuration, the planar surface can be engaged to the planar object directly or through the pillow case. In another embodiment, the exterior and interior frames can cooperate to pinch the planer object to the planar support surface as with the replaceable sheet.

A method, according to an embodiment of the present invention, of releasably affixing a replaceable sheet to a pillow case comprises positioning an interior frame member having a first plurality of integrated magnets against the interior face of the pillow case, wherein the interior frame member defines a first opening. The method can further comprise positioning a replaceable sheet against the exterior face of the pillow case and aligning the replaceable sheet with the interior frame member, wherein the replaceable sheet is larger than the first opening. The method can also comprise aligning an exterior frame member having a second plurality of integrated magnets with the interior frame member and positioning the exterior frame member against the exterior face of the pillow case such that the first and second pluralities of integrated magnets magnetically engage to secure the interior and exterior frame members together and releasably affix the replaceable sheet to the pillow case. Finally, the method can comprise pulling the interior and exterior frame members apart to disengage the pluralities of magnets and remove the replaceable sheet.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a perspective view of a representative pillow for use with the present invention.

FIG. 2 is a side view of the representative pillow of FIG. 1.

FIG. 3 is a partial cross-sectional perspective view of a clamping system according to an embodiment of the present invention.

FIG. 4 is a partial cross-sectional side view of a clamping system according to an embodiment of the present invention.

FIG. 5 is a partial cross-sectional side view of a clamping system according to an embodiment of the present invention.

FIG. 6 is a partial cross-sectional perspective view of a clamping system according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

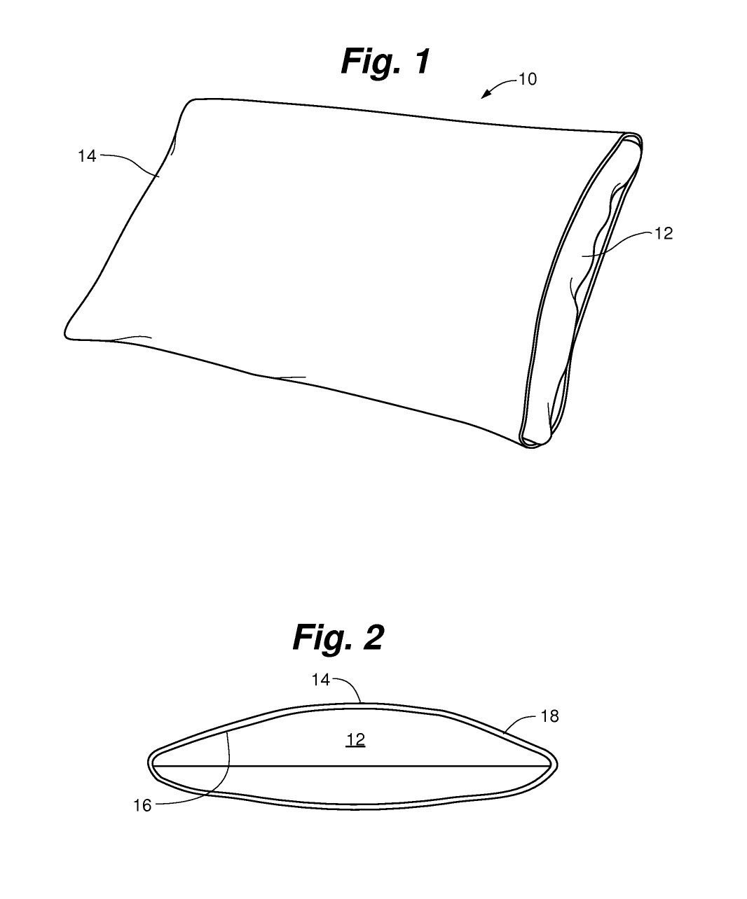

As shown in FIGS. 1-2, a pillow 10 for use with the present invention comprises a cushion 12 and a pillow case 14 defining a pocket for receiving the cushion 12. The pillow case 14 can comprise an interior face 16 positioned proximate to the cushion 12 when the cushion 12 is positioned within the pillow case 14. The pillow case 14 can also comprise an exterior face 18 opposite the interior face 16. As depicted in FIGS. 1-2, the pillow 10 comprises a conventional rectangular pillow for a bed, but can comprise any conventional pillow type of shape. As depicted, the pillow 10 is a bedroom pillow, but can include any cushion 12 covered by a case 14 including, but not limited to throw pillows, removable sofa cushions and floor pillows. The present invention can be used with any cushions with covers including cushions that are integrated into other furniture items including, but not limited to headrests, integrated sofa cushions, or padded chairs. The description of the pillow 10 is not intended to be limiting, but is provided to aid in the description of the present invention.

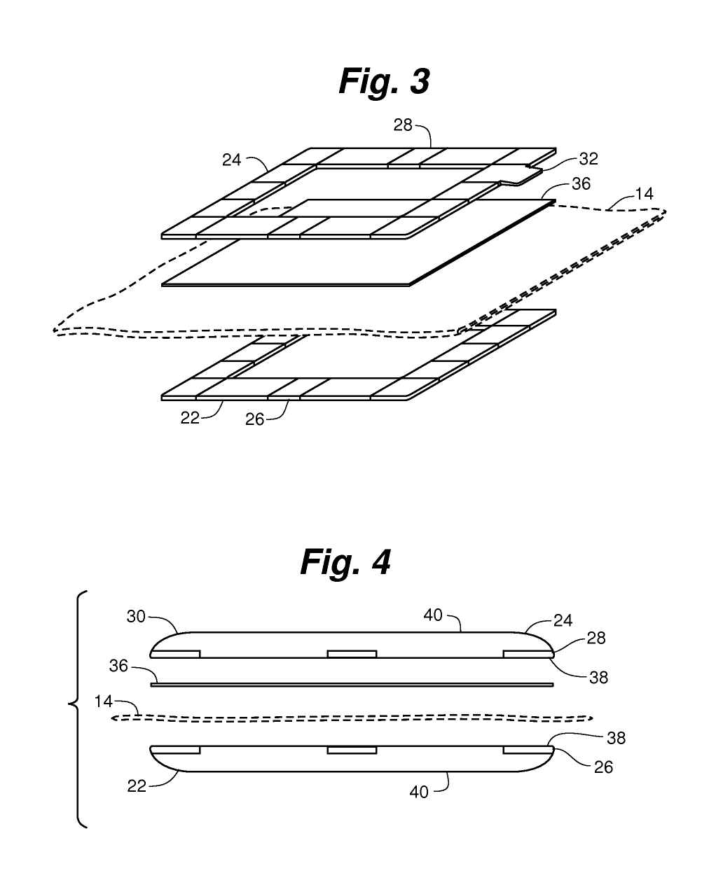

As shown in FIG. 3-4, a clamping system 20, according to an embodiment of the present invention, comprises an interior frame member 22 and an exterior frame member 24. The interior frame member 22 further comprises a first plurality of magnets 26 positioned around the periphery of the interior frame member 22. Similarly, the exterior frame member 24 further comprises a second plurality of magnets 28 positioned around the periphery of the exterior frame member 24. In one aspect, the first and second pluralities of magnets 26, 28 can comprise magnets between ¼ and ¾ inch in diameter. In another aspect, the magnets can be between ¼ and ½ inch in diameter. Similarly, in one aspect, the magnets have a thickness of less than 1/16 inches. In yet another aspect, the magnets have a thickness of less than 1/32 inches.

As depicted, the interior and exterior frame members 22, 24 each comprise a planar rectangular frame defining an opening. The openings are sized to receive a user's head or body part without contacting the frame members 22, 24. In one aspect, the frame members 22, 24 can each comprise a 14 inch by 18 inch rectangular shape, wherein the frame member 22, 24 is one inch wide such that the opening is 12 inches by 16 inches in size.

In one aspect, the frame members can comprise a rubberized, foam or other cushioning material to avoid causing discomfort to the user when resting on the pillow 10. Similarly, the frame members 22, 24 can further comprise rounded edges 30 to further minimize the likelihood the frame members 22, 24 will cause the user discomfort when using the pillow. In one aspect, the frame members 22, 24 can further comprise at least one tab 32 protruding outward from at least one edge of the frame member 22, 24. In another aspect, the tab 32 can extend outwardly ½ inch from the frame member 22, 24.

As shown in FIGS. 3-4, in operation, the interior frame member 22 is inserted into the pillow case 14 and positioned between the interior face 16 and the cushion 12. The exterior frame member 24 is positioned against the exterior face 18 and aligned with the interior frame member 22 such that the first and second pluralities of magnets 26, 28 magnetically engage each other. A replaceable sheet 36 is positioned between the exterior face 18 of the pillow case 14 and the exterior frame member 24 such that the replaceable sheet 36 is affixed to the exterior face 18 of the pillow case 14 when the frame members 22, 24 are magnetically engaged to each other. In one aspect, a stack of replaceable sheets 32 can be positioned between the exterior frame member 24 and the pillow case 14. In this configuration, the frame members 22, 24 can be pulled apart to remove the topmost sheet 36 and expose a clean sheet 36.

In an embodiment of the present invention, the frame members 22, 24 can each further comprise a flat face 38 and a rounded face 40. In this configuration, the first and second pluralities of magnets 26, 28 are oriented such that the flat faces 38 of the frame members 22, 24 face each other when the frame members 22, 24 are magnetically engaged.

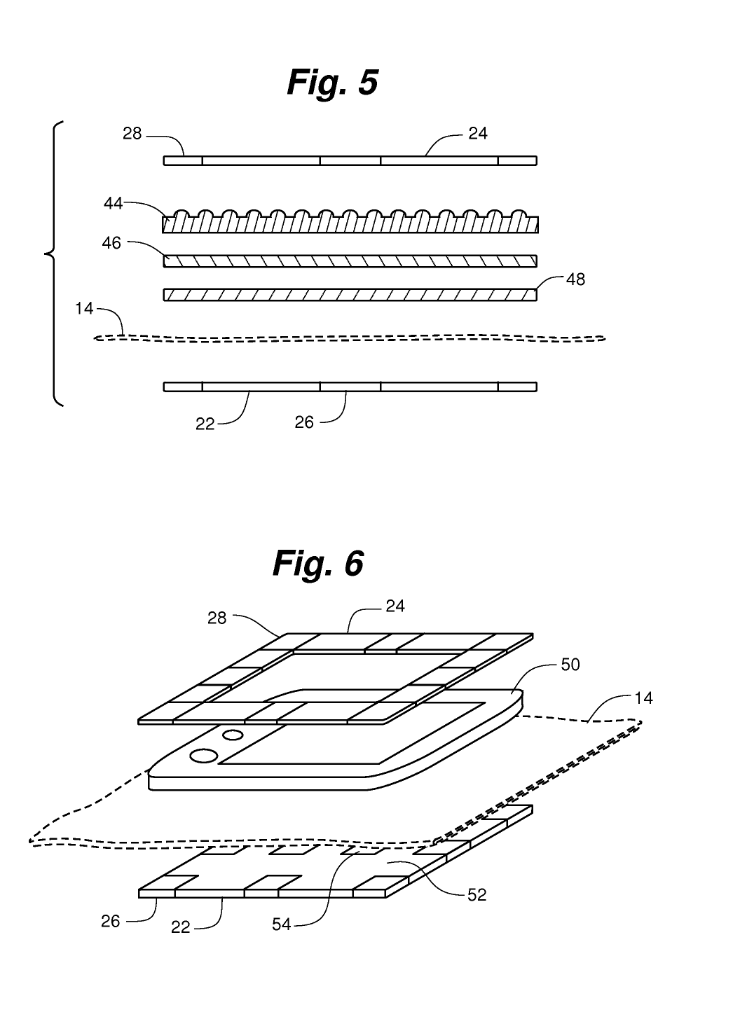

In one aspect, the replaceable sheet 36 can comprise a disposable sheet 42 that can be discarded after use or a reusable sheet (not pictured) that can be laundered and reused. In one embodiment, the disposable sheet 42 comprises at least two absorbent layers placed over a barrier layer. As shown in FIG. 5, in one aspect, the disposable sheet 42 can comprise a textured rayon top layer 44, an un-textured rayon middle layer 46 and a waterproof plastic or wax bottom layer 48. Similarly, the reusable sheet can comprise a washable material that can be removed and laundered before being reengaged to the pillow case 14 by the clamping system 20.

As shown in FIG. 6, in one embodiment, the claims system 20 can be used to engage a generally planar object 50. The object 50 can include, but is not limited to a mirror, writing surface, dry erase board, a tablet computer and other generally planar objects 50. In this configuration, the pillow 10 can act as a support or lap cushion to assist the user in using the planar object 50. In one aspect, the inner or exterior frame member 22, 24 can further comprise a planar support surface 52 integrated into the frame member 22, 24. In this configuration, the planar support surface 52 can further comprise a third plurality of magnets 54 engagable to a metallic planar object 50 or a corresponding set of magnets affixed to the planar object 50. In another aspect, the planar support surface 52 is a separate element that can be engaged to either the inner frame member 22 or exterior frame member 24. In this configuration, the third plurality of magnets 54 can be engaged to the first plurality of magnets 26 and/or the second plurality of magnets 28. In another aspect, the planar support surface 52 can further comprise a fourth plurality of magnets 56 engagable to the second plurality of magnets 28. In another aspect, the entire planar support surface 52 can be magnetized to engage the planar object 50. The planar support surface 52 can independently retain the planar object 50 to the pillow 10 or cooperate with inner and/or exterior frame member 22, 24 to retain the planar object 50.

As shown in FIGS. 3-4, a method, according to an embodiment of the present invention, of releasably affixing a replaceable sheet 36 to a pillow case 14 comprises positioning an interior frame member 22 having a first plurality of integrated magnets 26 against the interior face of the pillow case 14, wherein the interior frame member 22 defines a first opening. The method can further comprise positioning a replaceable sheet 36 against the exterior face 18 of the pillow case 14 and aligning the replaceable sheet 36 with the interior frame member 22, wherein the replaceable sheet 36 is larger than the first opening. The method can also comprise aligning an exterior frame member 24 having a second plurality of integrated magnets 28 with the interior frame member 22 and positioning the exterior frame member 24 against the exterior face 18 of the pillow case 14 such that the first and second pluralities of integrated magnets 26, 28 magnetically engage to secure the interior and exterior frame members 22, 24 together and releasably affix the replaceable sheet 40 to the pillow case 14. Finally, the method can comprise pulling the interior and exterior frame members 22, 24 apart to disengage the pluralities of magnets 26, 28 and remove the replaceable sheet 36.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A clamping system for releasably engaging a replaceable sheet to a pillow case, said pillow case having an interior face positioned proximate to a cushion and an exterior face opposite the interior face, the clamping system comprising:
an interior frame member positionable between the interior face of the pillow case and the cushion and having a first periphery portion defining a first opening; wherein a first plurality of magnets is positioned around the periphery portion of the interior frame; and
an exterior frame member positionable proximate to the exterior face of the pillow case and having a second periphery portion defining a second opening; wherein a second plurality of magnets is positioned around the periphery portion of the exterior frame;
wherein the first periphery portion of the interior frame member aligns with the second periphery portion of the exterior frame so that the first and second pluralities of magnets align pinch at least one replaceable sheet between the exterior frame and the exterior face of the pillow case.

2. The clamping system of claim 1, wherein the first and second openings are sized to receive a user's head or body part without contacting the first and second periphery portion.

3. The clamping system of claim 1, wherein the first frame member comprises a first rounded edge extending around the first periphery portion; wherein the second frame member comprises a second rounded edge extending around the second periphery portion.

4. The clamping system of claim 1, wherein the first and second frame members further comprise a padded cushioning layer.

5. The clamping system of claim 1, wherein each magnet is less than 1/16 inches thick.

6. The clamping system of claim 1, wherein each magnet is less than 1/32 inches thick.

7. The clamping system of claim 1, wherein a plurality of replaceable sheets are stacked between the exterior frame member and the exterior face of the pillow case, wherein the only the topmost replaceable sheet is accessible through the second opening.

8. The clamping system of claim 1, wherein the interior frame member comprises a first rounded face and a first flat face and the exterior frame member comprises a second rounded face and a second flat face; and
wherein the first and second pluralities of magnets are oriented to pull the first and second flat faces together when magnetically engaged.

9. The clamping system of claim 1, wherein each replaceable sheet comprises at least two absorbent layers and at least one barrier layer.

10. A pillow providing a replaceable sleeping surface, comprising:
a cushion;
a pillow case having an interior face positioned proximate to the cushion and an exterior face opposite the interior face;
an interior frame member positionable between the interior face of the pillow case and the cushion and having a first periphery portion defining a first opening; wherein a first plurality of magnets is positioned around the periphery portion of the frame; and
an exterior frame member positionable proximate to the exterior face of the pillow case and having a second periphery portion defining a second opening; wherein a second plurality of magnets is positioned around the periphery portion of the frame;
wherein the aligning the first periphery portion of the interior frame member with the second periphery portion of the exterior frame magnetically engages first and second pluralities of magnets to hold at least one replaceable sheet between the exterior frame and the exterior face of the pillow case.

11. The pillow of claim 10, wherein the first and second openings are sized to receive a user's head or body part through the openings to contact the cushion without contacting the first and second periphery portion.

12. The pillow of claim 10, wherein the first frame member comprises a first rounded edge extending around the first periphery portion; wherein the second frame member comprises a second rounded edge extending around the second periphery portion.

13. The pillow of claim 10, wherein the first and second frame members further comprise a padded cushioning layer.

14. The pillow of claim 10, wherein each magnet is less than 1/16 inches thick.

15. The pillow of claim 10, wherein each magnet is less than 1/32 inches thick.

16. The pillow of claim 10, wherein a plurality of replaceable sheets are stacked between the exterior frame member and the exterior face of the pillow case, wherein the only the topmost replaceable sheet is accessible through the second opening.

17. The clamping system of claim 10, wherein the interior frame member comprises a first rounded face and a first flat face and the exterior frame member comprises a second rounded face and a second flat face;
wherein the first and second pluralities magnets are oriented to pull the first and second flat faces together when magnetically engaged.

18. The clamping system of claim 10, wherein each replaceable sheet comprises at least two absorbent layers and at least one barrier layer.

19. A method of providing a replaceable sleeping surface on a pillow having a pillow case having an interior face positioned proximate to a cushion and an exterior face opposite the interior face, comprising:
positioning an interior frame member between the interior face of the pillow case and the cushion, wherein the interior frame ember comprising a first plurality of magnets is positioned around the periphery portion of the frame;
aligning a first replaceable sheet on the exterior face of the pillow case with the interior frame member;
positioning an exterior frame member comprising a second plurality of magnets over the replaceable sheet such that the second plurality of magnets magnetically engages the first plurality of magnets to pin the replaceable sheet between the exterior frame member and the exterior face of the pillow case;
pulling the exterior frame member away from the exterior face of the pillow case to disengage the first and second pluralities of magnets; and
replacing the first replaceable sheet with a second replaceable sheet.

20. The method of claim 20, furthering comprising:
placing a plurality of stacked replaceable sheets between the exterior frame member and the exterior face of the pillow case, wherein the first replaceable sheet is the topmost replaceable sheet;
wherein replacing the first replaceable sheet with a second replaceable sheet comprises removing the first replaceable sheet from the top of the stack to expose the second replaceable sheet beneath.
